(19) United States
(12) Patent Application Publication
(10) Pub. No.: US 2016/0026579 A1
(43) Pub. Date: Jan. 28, 2016

(54) Storage Controller and Method for Managing Metadata Operations in a Cache

(71) Applicant: LSI Corporation, San Jose, CA (US)

(72) Inventors: Sumanesh Samanta, Bangalore (IN); Suagata Das Purkayastha, Bangalore (IN); Mark Ish, Sandy Springs, GA (US); Horia Simionescu, Foster City, CA (US); Luca Bert, Cumming, GA (US)

(21) Appl. No.: 14/338,073

(22) Filed: Jul. 22, 2014

(51) Int. Cl. G06F 12/12; G06F 12/08

(52) U.S. Cl. CPC G06F 12/122; G06F 12/0891; G06F 2212/69; G06F 2212/603

(57) ABSTRACT

A cache controller having a cache supported by a non-volatile memory element manages metadata operations by defining a mathematical relationship between a cache line in a data store exposed to a host system and a location identifier associated with an instance of the cache line in the non-volatile memory. The cache controller maintains most recently used bit maps identifying data in the cache, as well as a data characteristic bit map identifying data that has changed since it was added to the cache. The cache controller maintains a most recently used bit map to replace the recently map at an appropriate time and a fresh bitmap tracks the most recently used bit map. The cache controller uses a collision bitmap, an imposter index and a quotient to modify cache lines stored in the non-volatile memory element.

### TECHNICAL FIELD

The invention relates generally to data storage systems and, more specifically, to data storage systems employing a flash-based data cache.

### BACKGROUND

Some conventional computing systems employ a memory device as a block or file level storage alternative for slower data storage devices to improve performance of the computing system and/or applications executed by the computing system. In this respect, because input/output (I/O) operations can be performed significantly faster to some memory devices (hereinafter a “cache device” for simplicity) than from or to a slower storage device (e.g., a magnetic hard disk drive), use of the cache device provides opportunities to significantly improve the rate of I/O operations.

For example, in the system illustrated in FIG. 1, a data storage manager 10 controls a storage array 12 in a manner that enables reliable data storage. A host (computer) system 14 stores data in and retrieves data from storage array 12 via data storage manager 10. That is, a processor 16, operating in accordance with an application program or APP 18, issues requests for writing data to and reading data from storage array 12. Although for purposes of clarity host system 14 and data storage manager 10 are depicted in FIG. 1 as separate elements, it is common for a data storage manager 10 to be physically embodied as a card that plugs into a motherboard or backplane of such a host system 14.

Such systems may cache data based on the frequency of access to certain data stored in the data storage devices 24, 26, 28 and 30 of storage array 12. This cached or “hot” data, e.g., element B, is stored in a cache memory module 21, which can be a flash-based memory device. The element B can be identified at a block level or file level. Thereafter, requests issued by applications, such as APP 18, for the “hot” data are serviced by the cache memory module 21, rather than the storage array 12. Such conventional data caching systems are scalable and limited only by the capacity of the cache memory module 21.

A redundant array of inexpensive (or independent) disks (RAID) is a common type of data storage system that addresses the reliability by enabling recovery from the failure of one or more storage devices. It is known to incorporate data caching in a RAID system. In the system illustrated in FIG. 1, data storage manager 10 includes a RAID processing system 20 that caches data in units of blocks, which can be referred to as read cache blocks (RCBs) and write cache blocks (WCBs). The WCBs comprise data that host system 14 sends to the data storage manager 10 as part of requests to store the data in storage array 12. In response to such a write request from host system 14, data storage manager 10 caches or temporarily stores a WCB in one or more cache memory modules 21, then returns an acknowledgement message to host system 14. At some later point in time, data storage manager 10 transfers the cached WCB (typically along with other previously cached WCBs) to storage array 12. The RCBs comprise data that data storage manager 10 has frequently read from storage array 12 in response to read requests from host system 14. Caching frequently requested data is more efficient than reading it from storage array 12 each time host system 14 requests it, since cache memory modules 21 are of a type of memory, such as flash-based memory, that can be accessed much faster than the type of memory (e.g., disk drive) that data storage array 12 uses.

Flash-based memory offers several advantages over magnetic hard disks. These advantages include lower access latency, lower power consumption, lack of noise, and higher robustness to environments with vibration and temperature variation. Flash-based memory devices have been deployed as a replacement for magnetic hard disk drives in a permanent storage role or in supplementary roles such as caches.

Flash-based memory is a unique memory technology due to the sensitivity of reliability and performance to write traffic. A flash page (the smallest division of addressable data for read/write operations) must be erased before data can be written. Erases occur at the granularity of blocks, which contain multiple pages. Only whole blocks can be erased. Furthermore, blocks become unreliable after some number of erase operations. The erase before write property of flash-based memory necessitates out-of-place updates to prevent the relatively high latency of erase operations from affecting the performance of write operations. The out-of-place updates create invalid pages. The data in the invalid pages are relocated to new locations with surrounding invalid data so that the resulting block can be erased. This process is commonly referred to as garbage collection. To achieve the objective, valid data is often moved to a new block so that a block with some invalid pages can be erased. The write operations associated with the move are not writes that are performed as a direct result of a write command from the host system and are the source for what is commonly called write amplification. As indicated above, flash-based memories have a limited number of erase and write cycles. Accordingly, it is desirable to limit these operations.

In addition, as data is written to a flash-based memory it is generally distributed about the entirety of the blocks of the memory device. Otherwise, if data was always written to the same blocks, the more frequently used blocks would reach the end of life due to write cycles before less frequently used blocks in the device. Writing data repeatedly to the same blocks would result in a loss of available storage capacity over time. Consequently, it is important to use blocks so that each block is worn or used at the same rate throughout the life of the drive. Accordingly, wear leveling or the act of distributing data across the available storage capacity of the memory device generally is associated with garbage collection.

In order to recover from power outages and other events or conditions, which can lead to errors and data loss, metadata or data about the information in the cache is desired to be stored in a persistent manner. For some storage controllers connected to large permanent data stores, the cache storage can be as large as several terabytes. A tiered data arrangement includes a data store supported by hard disk drives (HDDs) devices arranged in a RAID configuration, a large cache supported by one or more solid state devices (SSDs) and a relatively smaller cache supported by one or more dynamic random access memory modules or DRAM on the storage controller. In order to recover from power outages and other events or conditions, which can lead to errors and data loss, metadata or data about the information in the cache is desired to be stored in a persistent manner. Most applications take advantage of the flash-based storage device and use a portion of the available storage capacity to save the metadata in the one or more flash-based memory devices supporting the cache. However, such storage increases the write amplification as each new cache write includes a corresponding update to the metadata. Some conventional systems log or track the metadata or data about the data in the cache in divisions or portions commonly referred to as cache windows. These cache windows were frequently allocated a storage capacity that wasted SSD space when relatively smaller random input/output (I/O) operations had to be logged.

In general, it is undesirable to decrease the window size as such a change increases the storage capacity requirements of the dual data rate memory modules in the storage controllers, which then have to manage many more cache windows. For example, for a fully flexible 64 Kbyte cache line with dynamic memory mapping approximately 1 Gbyte of double-data rate (DDR) random access memory (RAM) is required to support each terabyte of SSD storage. DDR storage requirements increase linearly with the SSD storage capacity and double when a full virtual cache is desired. A 64 Kbyte READ cache fill has been identified as a root cause of lower endurance, write amplification and reduced SSD life. A corresponding 64 Kbyte WRITE fill prohibits use of the cache as a write buffer, since it results in a read-modify write. In addition to the above capacity requirements and problems associated with a 64 Kbyte cache line, it may be desirable to track data at a granularity or resolution smaller than a 64 Kbyte cache line. For example, it may be desirable to track cached data at a 4 Kbyte granularity. At this granularity, the metadata capacity requirements map to a DDR capacity which is not available in today's storage controllers.

### SUMMARY

Embodiments of a storage controller and method for managing metadata in a cache are illustrated and described in exemplary embodiments.

In an example embodiment, a storage controller includes a first interface, a processor coupled to the first interface, a memory element coupled to the processor by a bus, and a second interface coupled to the processor by the bus. The first interface communicates data and commands with a host system. The second interface communicates data and commands with a set of data storage elements supporting a logical volume used by the host system. The memory element includes state machine logic responsive to a quotient and a set of functions that define a cache address from a host managed address and a host managed addressed from a cache address. The state machine logic manages the reuse of cache line addresses responsive to recently used bitmaps. The state machine logic uses information from a global bitmap, a collision bitmap and an imposter index.

In another exemplary embodiment, a method for managing metadata operations in a cache store supported by a solid-state memory element is disclosed. The method includes the steps of defining a relationship between a segment in a data store exposed to a host system and a location identifier associated with a cache line location in the solid state-memory element, using a quotient factor and a target identifier to determine when requested data is present in the cache, maintaining a set of bitmaps that define at least one characteristic of data present in the cache, maintaining a recently used bitmap that is available to replace the most recently used bitmap, recording a collision bitmap, an imposter index, the target identifier and a quotient for respective cache lines in the cache and using one or more of the collision bitmap, the imposter index and the quotient to modify cache lines stored in the cache.

### BRIEF DESCRIPTION OF THE DRAWINGS

FIG. 1 is a block diagram illustrating a conventional cache device coupled to a host computer and a storage system.

FIG. 2 is a block diagram illustrating an improved storage controller in accordance with an exemplary embodiment of the invention.

FIG. 3 is a schematic illustration of cache line mapping between a source virtual disk and a cache.

FIGS. 4A and 4B include respective schematic illustrations of metadata structures implemented by the storage controller of FIG. 2.

FIG. 5 is a schematic illustration of associative functions that define a first mapping to transfer data into the cache and a reverse mapping to return data to the source VD.

FIG. 6 is a schematic illustration of a state diagram implemented by the state-machine logic and processor of FIG. 2.

FIG. 7 is a flow diagram illustrating a method for managing metadata operations in a cache supported by a solid-state memory element.

FIG. 8 is a flow diagram illustrating a method for processing a host system input/output operation.

### DETAILED DESCRIPTION OF AN ILLUSTRATIVE EMBODIMENT

In an exemplary embodiment, a flash-based cache store is sub-divided into 64 Kbyte cache lines. An identified block of 64 Kbyte of storage capacity in a source or host managed “disk” maps to a fixed address or location in the flash-based cache. A first mathematical formula or base function is used to determine a fixed or base location in the flash-based cache as a function of a constant, a logical disk index and a cache line index of the flash-based storage device. The base location will be used by the storage or cache controller to store data when the base location is not already storing data or is unused. For a given source disk, only a few 64 Kbyte storage blocks or cache lines can map to a given base location or address in the cache. The constant ensures a pseudo random distribution among source or host logical disks as determined by the mathematical formula. A second mathematical formula or first jump function identifies a first jump or offset location from the base location. The first jump location and any of the next L contiguous addresses in the metadata cache will be used if the base location is not available. A third mathematical formula or second jump function identifies a second jump or offset location from the base location. The second jump location is different from the first jump location. The second jump location and any of the next L contiguous addresses in the cache will be used if both the base location and the first jump location with its L contiguous addresses are all unavailable for storing a cache line. When L is the integer 8, the first, second and third functions or mathematical formulas define a 17-way set-associative cache. While the described embodiment identifies a 17-way set associative cache, alternative M-way set associative caches are contemplated, where M is an integer.

Note that when the first mathematical formula is random and defines a segment to cache line relationship that is unique the first and second jump or offset locations are optional. When this is the case, it is possible to use any number of the following cache line locations in lieu of the jump locations.

When a host I/O is received, it will first be checked if it is a cache “hit” in one of the M cache addresses. A collision bitmap is created and maintained in metadata for identifying where data is present or located in the cache. That is, a select logical value (e.g., a logical “1” value) in a specific location within the collision bitmap identifies when data is stored at a particular address or location in the cache. When data is not present in the cache, the collision bit map includes the opposed logical value (e.g., a logical “0” value) to the select or present logical value and such a condition is representative of a cache “miss.” The storage controller may be alternatively configured to identify presence with a logical “0” value and not present with a logical “1” value. When the I/O operation or request is logged or recorded as a cache “miss”, then a virtual window is allocated to support the I/O request and the cache is bypassed. Once a host I/O is identified by the storage controller as meeting the appropriate criteria to enter the cache, i.e., the data associated therewith has become “hot,” then a free cache line address is allocated to the I/O using one of the three mathematical formulas as may be required under present cache storage circumstances and the data from the source logical disk segment is inserted or stored in the cache.

Metadata structures responsive to the data in the cache are created and maintained by the storage controller to manage operations in the cache store. The storage controller populates the metadata structures and executes a cache line state machine. The cache line state machine defines five separate states of an individual cache line indicated by corresponding bits in a dirty bit map, a free bit map, a most recently used bit map and multiple levels of recently used bit maps. A cache line is defined as one of free, dirty recently used, dirty not recently used, recently used, and not recently used.

A cache line “n” is in the free state or “FREE” when the “n”-th bit in the free bit map is set to a predetermined logical value. In an example embodiment, the “n”-th cache line is free when a corresponding bit in the free bit map is a logical 0. The “n”-th cache line is used or not FREE when the corresponding bit in the free bit map is a logical 1. The logical values placed in the free bit map and the corresponding logic in the state machine may be alternatively arranged such that a logical 1 indicates that the “n”-th cache line is FREE.

A cache line “n” is in the recently used state or “RU” when the “n”-th bit in a highest order recently used bit map or when the “n”-th bit of an adjacent order recently used bit map is set to a predetermined logical value. In an example embodiment, the “n”-th cache line is RU when a corresponding bit in either of the described recently used bit maps is a logical 1. The “n”-th cache line is in the not recently used state when the corresponding “n”-th bit in both of the described recently used bit maps are a logical 0. The logical values placed in the recently used bit maps and the corresponding logic in the state machine may be alternatively arranged such that a logical 0 indicates that the “n”-th cache line is RU.

A cache line is in the dirty recently used state or “DRU” when it satisfies the condition of the recently used state and an “n”-th bit in a dirty bit map is set to a predetermined logic value. A cache line is dirty when the underlying data has changed in the cache from that which is presently stored in a corresponding logical block address in a data volume exposed to the host system. In an example embodiment, the “n”-th cache line is in the DRU state when it is satisfies the condition for recently used and the corresponding bit in the dirty bit map is set to a logical 1.

A cache line is in the dirty not recently used state or “DNRU” when it satisfies the condition of the NRU state and an “n”-th bit in a dirty bit map is set to a predetermined logic value. In an example embodiment, the “n”-th cache line is in the DNRU state when it satisfies the condition for not recently used and the corresponding bit in the dirty bit map is set to a logical 1. The logical values placed in the dirty bit map and the corresponding logic in the state machine may be alternatively arranged such that a logical 0 indicates that the “n”-th cache line is dirty.

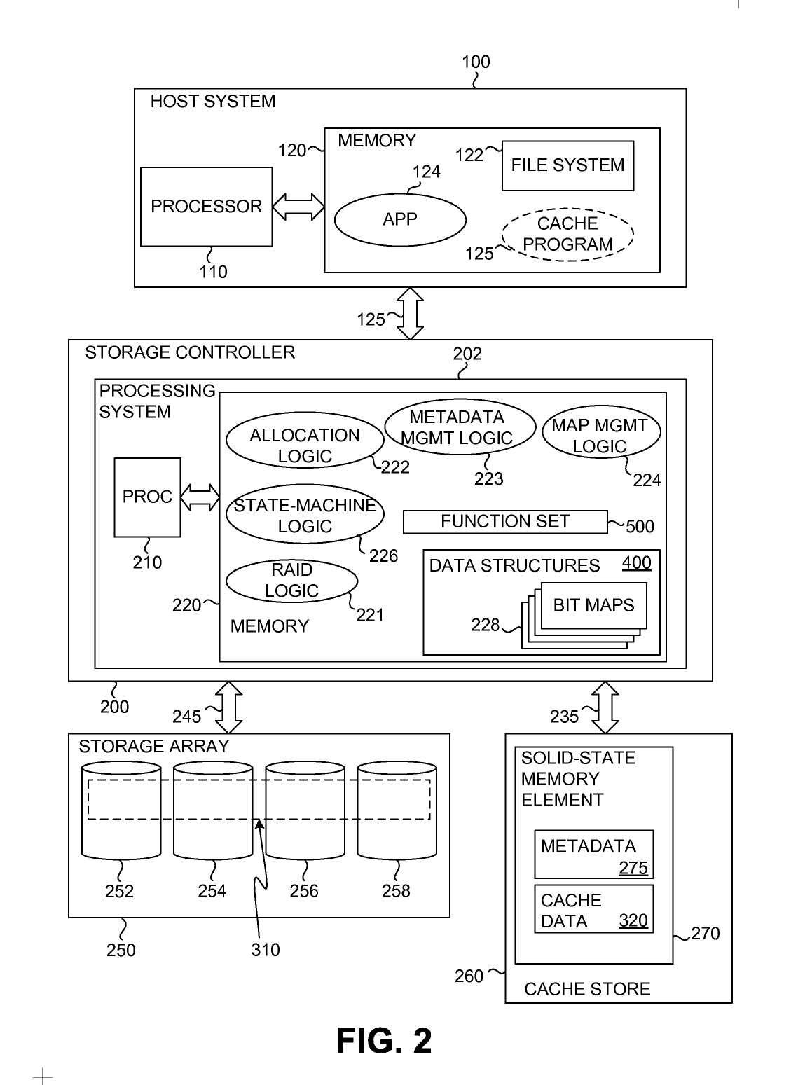

As illustrated in FIG. 2, in an illustrative or exemplary embodiment, host system 100 is coupled by way of a storage controller 200 to a storage array 250 and a cache store 260. The host system 100 communicates data and commands with the storage controller 200 over bus 125. The storage controller 200 communicates data and commands with the storage array 250 over bus 245 and communicates with the cache store 260 over bus 235. In an example embodiment, the bus 125 is a peripheral component interconnect express (PCIe) compliant interface.

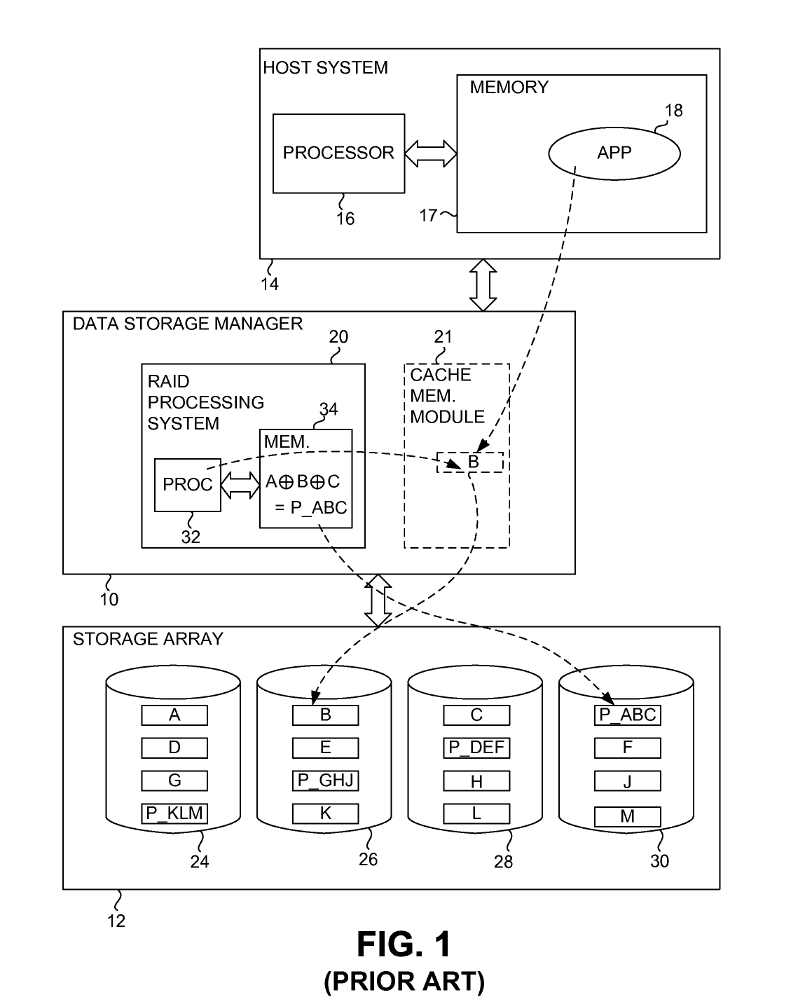

The storage array 250 can be a direct attached storage (DAS) or a storage area network (SAN). In these embodiments, the storage array 250 includes multiple data storage devices, such as those described in association with the storage array 12 (FIG. 1). When the storage array 250 is a DAS, the bus 245 can be implemented using one or more advanced technology attachment (ATA), serial advanced technology attachment (SATA), external serial advanced technology attachment (eSATA), small computer system interface (SCSI), serial attached SCSI (SAS) or Fibre Channel compliant interfaces.

In an alternative arrangement, the storage array 250 can be a network attached storage (NAS) array. In such an embodiment, the storage array 250 includes multiple data storage devices, such as those described in association with the storage array 12 (FIG. 1). In the illustrated embodiment, the storage array 250 includes physical disk drive 252, physical disk drive 254, physical disk drive 256 and physical disk drive 258. In alternative arrangements, storage arrays having less than four or more than four physical storage devices are contemplated. When the storage array 250 is a NAS, the bus 245 can be implemented over an Ethernet connection, which can be wired or wireless. In such arrangements, the storage controller 200 and storage array 250 may communicate with one another using one or more of hypertext mark-up language (HTML), file transfer protocol (FTP), secure file transfer protocol (SFTP), Web-based distributed authoring and versioning (Webdav) or other interface protocols.

Host system 100 stores data in and retrieves data from the storage array 250. That is, a processor 110 in host system 100, operating in accordance with an application program 124 or similar software, issues requests for reading data from and writing data to storage array 250. In addition to the application program 124, memory 120 further includes a file system 122 for managing data files and programs. As indicated in FIG. 2, the memory 120 may include a cache program 125 (shown in broken line) that when executed by the processor 110 is arranged to identify the frequency with which programs, files or other data are being used by the host system 100. Once such items cross a threshold frequency they are identified as “hot” items that should be stored in cache such as cache store 260. The cache program 125 is shown in broken line as the functions associated with identifying, storing, maintaining, etc. “hot” data in a cache are preferably enabled within the processing system 202 of the storage controller 200. When so arranged, the logic and executable instructions that enable the cache store 260 may be integrated in memory 220. Such cache management logic may take the form of multiple modules, segments, programs, files, etc., which are loaded into memory 220 and communicated with processor 210 on an as-needed basis in accordance with conventional computing principles.

Although application program 124 is depicted in a conceptual manner as stored in or residing in a memory 120, persons of skill in the art can appreciate that such software may take the form of multiple modules, segments, programs, files, etc., which are loaded into memory 120 on an as-needed basis in accordance with conventional computing principles. Similarly, although memory 120 is depicted as a single element for purposes of clarity, memory 120 can comprise multiple elements. Likewise, although processor 110 is depicted as a single element for purposes of clarity, processor 110 can comprise multiple elements.

The storage controller 200 operates using RAID logic 221 to provide RAID protection, such as, for example, RAID-5 protection, by distributing data across multiple data storage devices, such as physical disk drive 252, physical disk drive 254, physical disk drive 256, and physical disk drive 258 in the storage array 250. As indicated by a dashed line, a source or host directed logical disk 310 is supported by storing data across respective portions of physical disk drive 252, physical disk drive 254, physical disk drive 256 and physical disk drive 258. Although in the exemplary embodiment storage devices 252, 254, 256 and 258 comprise physical disk drives (PDDs), the PDDs can be replaced by solid-state or flash memory modules. That the number of storage devices in storage array 250 is four is intended merely as an example, and in other embodiments such a storage array can include any number of storage devices.

The cache store 260 is arranged to improve performance of applications such as APP 124 by strategically caching the most frequently accessed data in the storage array 250 in the cache store 260. Host system based software such as cache software 125 is designed to detect frequently accessed data items stored in storage array 250 and store them in the cache store 260. The cache store 260 is supported by a solid-state memory element 270, which supports data transfers at a significantly higher rate than that of the storage array 250. The solid-state memory element 270 is capable of storing cache data 320 and metadata or data structures 400.

A cache controller (not shown) of the solid-state memory element 270 communicates with storage controller 200 and thus host system 100 and storage array 250 via bus 235. The bus 235 supports bi-directional data transfers to and from the solid-state memory element 270. The bus 235 may be implemented using synchronous or asynchronous interfaces. A source synchronous interface protocol similar to a DDR SRAM interface is capable of transferring data on both edges of a bi-directional strobe signal. When the solid-state memory element 270 includes not logical AND memory cell logic or NAND flash memory, the solid-state memory element 270 is controlled using a set of commands that may vary from device to device. In some embodiments, the solid-state memory element 270 can be physically embodied in an assembly that is pluggable into storage controller 200 or a motherboard or backplane (not shown) of host system 100 or in any other suitable structure.

Storage controller 200 includes a processing system 202 comprising a processor 210 and memory 220. Memory 220 can comprise, for example, synchronous dynamic random access memory (SDRAM). Although processor 210 and memory 220 are depicted as single elements for purposes of clarity, they can comprise multiple elements. Processing system 202 includes the following logic elements: RAID logic 221, allocation logic 222, metadata management logic 223, map management logic 224, and state-machine logic 226. In addition, the memory 220 will include a plurality of bit maps 228, a set of associative functions and a host of other data structures 400 for monitoring and managing data transfers to and from the cache store 260. As described, the memory 220 may further include cache logic (not shown) equivalent or similar to cache software 125 to detect frequently accessed data items stored in storage array 250 and store them in the cache store 260.

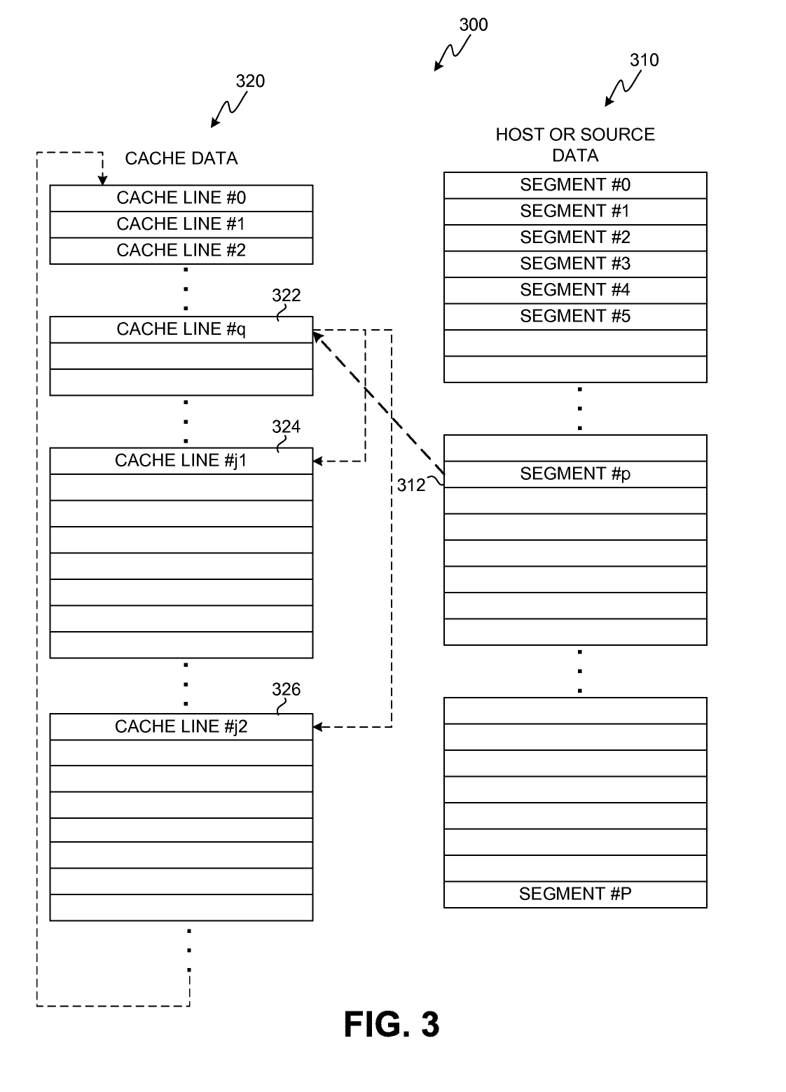

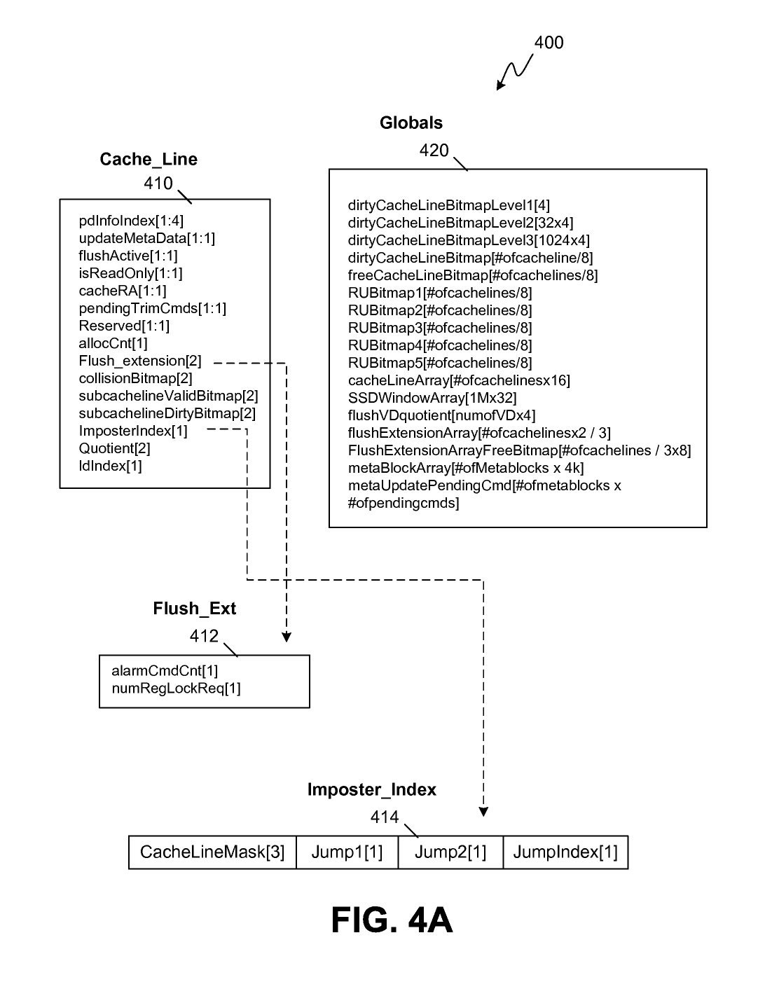

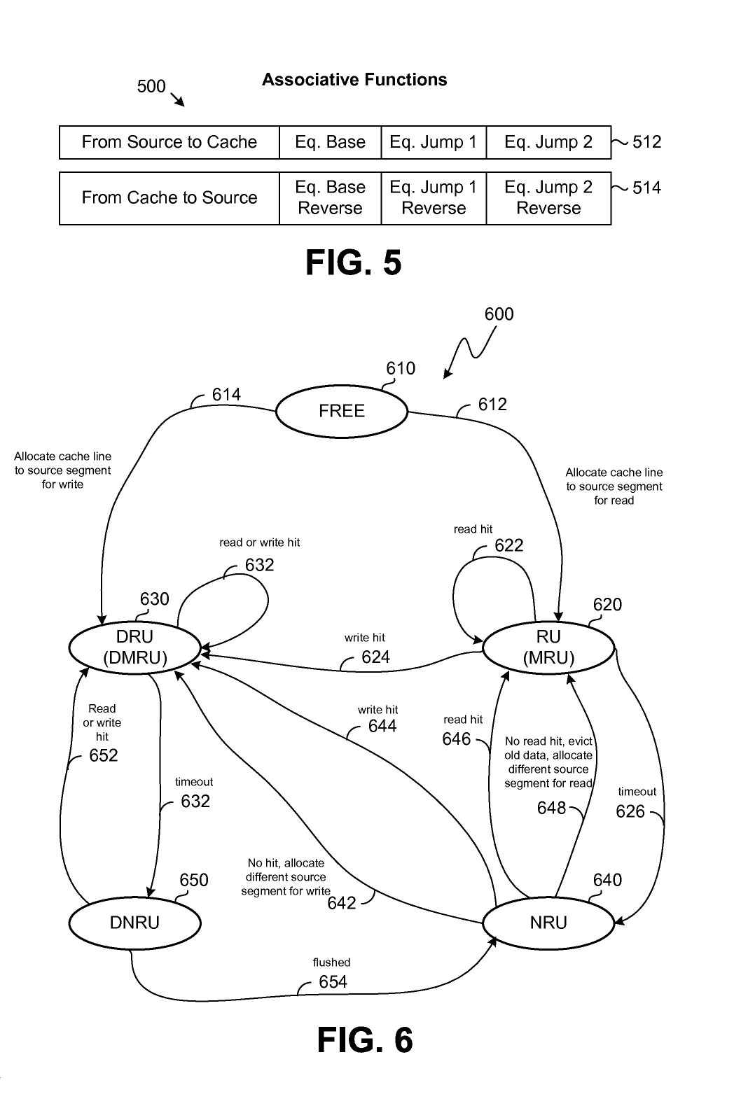

These logic elements or portions thereof together with data structures 400, associative functions or function set 500 and bit maps 228 are used by the processing system 202 to enable the methods described below. Both direct and indirect mapping between a source logical disk(s) 310 and cache data 320, enabled by use of the function set 500, as executed by the processor 210, are described in association with the illustration in FIG. 3. Data structures, including the various bit maps and their use are described in detail in association with the description of the illustration in FIG. 4A and FIG. 4B. The architecture and operation of the state-machine logic 226 is described in detail in association with the description of the state diagram in FIG. 6.

The term “logic” or “logic element” is broadly used herein to refer to control information, including, for example, instructions, and other logic that relates to the operation of storage controller 200 in controlling data transfers to and from the cache store 260. Furthermore, the term “logic” or “logic element” relates to the creation and manipulation of metadata in data structures 400. Note that although the above-referenced logic elements are depicted in a conceptual manner for purposes of clarity as stored in or residing in memory 220, persons of skill in the art can appreciate that such logic elements may take the form of multiple pages, modules, segments, programs, files, instructions, etc., which can be loaded into memory 220 on an as-needed basis in accordance with conventional computing principles as well as in a manner described below with regard to caching or paging methods in the exemplary embodiment. Unless otherwise indicated, in other embodiments such logic elements or portions thereof can have any other suitable form, such as firmware or application-specific integrated circuit (ASIC) circuitry.

FIG. 3 is a schematic illustration of cache line mapping between a source logical disk or source data 310 and cache data 320 within the cache store 260 of FIG. 2. The host or source data 310 is sub-divided into P segments, where P is an integer. Each of the segments of the source data 310 has the same storage capacity. Once a corresponding cache window becomes “hot” then a free cache line in the cache data 320 is allocated and the information stored in the data segment is transferred to the corresponding cache line to service future host system I/O requests for the information.

In an example embodiment, the cache lines each include 64Kbytes. A given source segment “p” will map to any of a select number of cache line addresses or locations in the cache data 320. A first mathematical function or base equation defines a first or base location 322 in the cache data 320. The first mathematical function or base equation is a function of a product of a constant and a logical disk index or target identifier. This product is summed with the index or position in sequence in the sub-divided source data 310 to generate a dividend for a modulo n division. The result of the modulo n division (also called remainder) identifies a base index or position “q” in the cache data 320.

An example first or base equation can be expressed as:

q=(constant*LD Index+p)% n Eq. 1

where, the constant (e.g., 0x100000) ensures the probability of cache lines from a different source 310 as defined by a LD Index or target identifier mapping to the same base location is unlikely, the LD Index is an identifier of a logical disk under the control of the host system 100, and n is an integer equal to the number of cache lines in the cache data 320.

A second mathematical function or first jump equation defines a first jump location 324 in the cache data 320 that is offset from the base location 322. The second mathematical function or first jump equation is a function of the remainder from Eq. 1. That is, the remainder from Eq. 1 is bit wise logically ANDed with ‘0x07.’ The result of this first operation is shifted to the left by three bits. The result of the second operation is added with the result of the division of the integer n by ‘4’. The result of these additional operations generates a second dividend for a modulo n division. The result of the second modulo n division identifies a first jump position j1 (a jump location 324) in the cache data 320. The example first jump equation can be expressed as:

j1=((n/4)+((q &0x07)<<3))% n Eq. 2

where, Eq. 2 defines eight cache lines starting at j1. These locations will wrap to the start of the cache locations if the end of the available cache locations is reached.

A third mathematical function or second jump equation defines a second jump location 326 in the cache data 320 that is offset from the base location 322. The third mathematical function or second jump equation is a function of the remainder from Eq. 1. That is, the remainder from Eq. 1 is bit wise logically ANDed with ‘0x07’. The result of this first operation is shifted to the left by three bits. The result of the second operation is added with the result of the product of the integer n and the ratio of 3/4. The result of these additional operations generates a third dividend for a modulo n division. The result of the third modulo n division identifies a second jump position j2 (a second jump location 326) in the cache data 320. The example second jump equation can be expressed as:

j2=((n*3/4)+((q &0x07)<<3))% n Eq. 3

where, Eq. 3 defines eight cache lines starting at j2. These locations will wrap to the start of the cache locations if the end of the available cache locations is reached. The base equation, first jump equation and second jump equation (i.e., Eq. 1, Eq. 2 and Eq. 3) define a 17-way set-associative cache.

Alternative arrangements are contemplated. In an example alternative embodiment, a 16-way set associative cache is defined using a two-step process. In a first step, a base location is determined in the same manner as in Eq. 1. In a second step, a coded base location q′ is determined as a function of the quotient determined in the first step. A given source segment can map to any of the 16 consecutive cache lines from this coded base location.

The adjusted quotient, q′, is determined as a bit-wise logical OR of first, second and third bit operations. The first operation includes a bit-wise logical AND of the remainder, q, and 0xFF, which is left shifted by 12 bits. The second operation includes a bit-wise logical AND of the remainder, q, and 0xFF000, which is right shifted by 12 bits. The third operation includes a bit-wise logical AND of the remainder, q, and 0xFFF00F00.

An example of the described second or quotient adjustment can be expressed as:

q′=(q&0xFF)<<12|(q&0xFF000)>>12|(q&0xFFF00F00)) Eq. 2 (alt.)

When a host I/O request is received, the host or source data index (also described as a target identifier) is used to generate the base location and/or one or both of the first and second jump locations as may be required. The corresponding locations in the cache data 320 are checked to determine if the cache data already includes the source data to be cached. When this data of interest is present in the cache, a cache “HIT” condition exists. When the data of interest is not present in the cache as determined after a comparison the data in the locations defined by the described equations, a cache “MISS” condition exists. When a cache MISS occurs, a virtual window is allocated and the cache data 320 is bypassed.

FIG. 4A is a schematic illustration of three representative data structures from a set of data structures 400 that are created by the storage controller 200 and stored in the memory 220 (FIG. 2). As indicated in FIG. 4A the representative data structures include a cache line structure 410, a flush extension 412, and a globals structure 420. Each of the three representative data structures include a respective set of separately recognized data fields of a desired storage capacity or size in logical bits. The data stored in the data fields is accessed and used by the storage controller 200 to manage the cache data 310.

In an example arrangement, a cache line structure 410 includes fifteen data fields that are populated and manipulated by various logic elements or modules within the storage controller 200 for each of the respective cache lines in the cache data 310. Alternative arrangements including other data fields are contemplated. Some members of this cache line structure 410 have a corresponding name and a similar function than that used in some conventional storage controllers that generate and maintain a cache. These members include a pdInfoIndex, updateMetaData, flushActive, isReadOnly, cacheRA, pendingTrimCmds, Reserved, allocCnt, subcachelineValidBitmap and subCacheineDirtyBitmap, flushextension, and IdIndex.

The pdInfoIndex data is the physical disk identifier of the SSD in a global physical disk pool or store of such storage elements. The updateMetaData field includes a bit or flag to indicate that the cache line metadata is getting updated. The flushActive field is a bit or flag that indicates that the respective cache line is getting flushed. The isReadOnly field includes a bit or flag to indicate that the data in the respective cache line is read only. The cacheRA field includes a bit or flag to indicate that the respective cache line should be subject to a read ahead operation. The pendingTrimCmds field includes a bit or flag to indicate that the respective cache line has a pending trim command. A trim command instructs the solid-state memory element as to the specific pages in the memory that should be deleted. At the time of the delete, the solid-state memory device controller can read a block into memory, erase the block and write back only those pages that include data. The allocCount field includes information that indicates when the respective cache line is associated with an ongoing I/O operation. The subcachelineValidBitmap and subcachelineDirtyBitmap fields include a respective bit for each subcache line within the respective cache line. The meaning of the bits of these two bitmaps are as follows, when all flags of subcachelineValidBitmap are 0 then it implies that the respective cache line is free. A bit set in the subcachelineValidBitmap implies that the corresponding subcache line is valid and resident in the current cache line. A bit set in the subcachelineDirtyBitmap implies that the corresponding subcache line is dirty. A dirty bit or modified bit is associated with a block of memory that has been modified when a processor writes to the subcache line. That is, a dirty bit indicates that the modified data has not been permanently stored in the storage array 250 (FIG. 2). The flush_extension field includes an index that identifies the flush extension array, which is relevant when the respective cache line is being flushed. The data is dynamically associated when the flush operation is active and removed once the flush operation completes. When the respective cache line is not getting flushed the data in the flush_extension field will contain a logical 0. The IdIndex field includes information that identifies the source data 310 (FIG. 3).

A Flush_Ext structure 412 includes two data fields that are populated and manipulated by various logic elements or modules within the storage controller 200. The Flush_Ext structure 412 includes alarmCmdsCnt and a numRegionLock Req fields. The alarmCmdsCnt and numRegionLockReq fields are used by the storage controller 200 to track the number of dirty read lines and the number of region locks pending when the respective cache line is getting flushed.

The remaining members of the cache line structure 410 are novel and include a collisionBitmap, an Imposterindex, a Quotient, and an Id Index. The collisionBitmap indicates which cache lines in the M-way set-associative cache lines (or which cache lines in an alternative set-associative cache) are used. When the collisionBitmap is set to 0, the direct mapped cache line as indicated by Equation 1 is used. When a bit ‘t’ is set in the lower significant 8-bits of the collisionBitmap, the t-th cache line from the jump1-th cache line, as indicated by Equation 2, is used. Otherwise, when a bit ‘t’ is set in the upper significant 8-bits of the collisionBitmap, the t-th cache line from the jump2-th cache line, as indicated by Equation 3, is used.

The imposterindex 414, as further identified in FIG. 4A, is an identifier including 1 byte of information that tracks or identifies the source segment identifier. The imposterindex 414 is split into following subfields, a cache line mask, a Jump1 flag, a jump2 flag and a Jumpindex. The cache line mask is the resultant (q & 0x07) value from Equation 2 or Equation 3. If the respective cache line was allocated directly after the mapping through Equation 1 then Jump1, Jump2, and Jumpindex will be 0. However, if the respective cache line was allocated after Jump1 (i.e., from Equation 2) then Jump1 will be set to 1, Jump2 will be set to 0 and the Jumpindex will be set to the value within the 8 consecutive slots where this cache line has been allocated. If the respective cache line was allocated after Jump2 (i.e., from Equation 3) then Jump2 will be set to 1, Jump1 to 0 and the Jumpindex will be set to the value within the 8 consecutive slots where the cache line has been allocated.

The quotient together with the imposterindex is used to identify the source segment ‘p’ which is currently mapped in this cache line in the cache data 320. Consider the cache line index in the cache store 320 is ‘q’. Then the corresponding source segment ‘p’ is derived as:

p=(quotient*n+q)−constant*LD Index)% n Eq. 4

where, the constant is the same constant used in Eq. 1.

When the imposterindex Jump1 sub-portion is set, then the corresponding source segment ‘p’ is derived as:

p=((quotient*n+q−j1)−constant*LD Index)% n Eq. 5

where, j1 is derived from Eq. 2 and the constant is the same constant used in Eq. 1.

When the imposterindex Jump2 sub-portion is set, then the corresponding source VD cache line ‘p’ is derived as:

p=((quotient*n+q−j2)−constant*LD Index)% n Eq. 6

where, j2 is derived from Eq. 3 and the constant is the same constant used in Eq. 1.

When the alternative set-associative mapping is used, the reverse mapping is done as follows. A quotient together with the imposterindex helps to derive the segment identifier of the source logical disk which is currently mapped in this cache line in cache store 260. Consider the cache store cache line is ‘q’. Then source segment ‘p’ is derived as,

Step1: q′=q−imposterindex

Step2: q″=(q′ & 0xFF)<<12|(q′ & 0xFF000)>>12|(q′ & 0xFFF00F00)

Step3: p=quotient*n+q″−constant*LD Index

One or more additional fields may be incorporated in the cache line structure 410 as may be desired to enable or provide additional metadata management functions or operations.

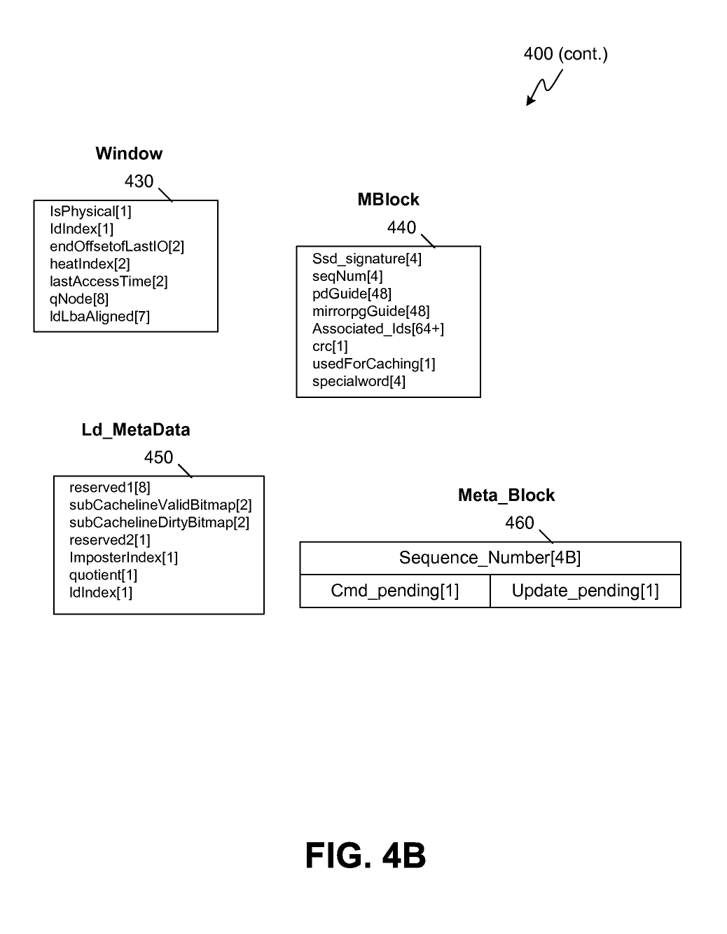

FIG. 5 schematically shows a set of associative functions 500. A first subset 512 includes three member equations or mathematical functions, the members of which may include Eq. 1 (also known as a base equation), Eq. 2 (also known as a first jump equation) and Eq. 3 (also known as a second jump equation.). The first subset 512, as further shown in FIG. 5, identify a mapping of a first location (i.e., a cache line) in the source data 310 to a corresponding set of M locations in the cache data 320, as described above in association with FIG. 3.

A second subset 514, like the first subset 512, includes three member equations or mathematical functions. However, the second subset 514 may include Eq. 4 (also known as a direct reverse equation or mapping), Eq. 5 (also known as first reverse jump equation or mapping) and Eq. 6 (also known as a second reverse jump equation or mapping). This second subset 514 of equations identifies a relationship between the M locations in the cache data 320 and a corresponding location in the source data 310.

In an example arrangement, as indicated in FIG. 4B, a window structure 430 includes seven data fields that are populated and manipulated by various logic elements or modules within the storage controller 200. The window structure 430 uses a contiguous storage space and is similar to or representative of a virtual window implemented in conventional cache management systems. The window structure 430 includes isPhysical, IdIndex, IdLbaAligned, endOffsetLastlO, heatIndex, lastAccessTime, qNode, IruNode data fields.

The isPhysical field includes information that identifies whether the corresponding window is physical or virtual. The IdIndex field includes an identifier that corresponds to the source data 310. The IdLbaAligned field holds the source data block number right shifted by 11 bits.

The remaining fields endOffsetLastlO, heatIndex, lastAccessTime, qNode, IruNode have similar meanings as those used in conventional virtual window structures. The endOffsetLastlO field includes information used to track sequential I/O operations. The heatIndex field includes information used to track the degree of hotness of the respective window. The lastAccessTime field includes information used in a heatIndex calculation. The qNode field includes information used by the storage controller 200 to track the respective window in a hash bucket. The IruNode field includes information that is used to track this window in a least recently used list.

A Id_MetaData structure 450 includes seven data fields that are populated and manipulated by various logic elements or modules within the storage controller 200 for each of the respective cache lines in the cache data 310. That is, for each cache line structure 410 there is a corresponding Id_MetaData structure 450 which includes a copy of some of the field information and where flags or bits that need not be saved are removed or replaced by logical 0 values.

A MetaData_Block structure 460 includes three data fields that are populated and manipulated by various logic elements or modules within the storage controller 200 for each of the respective cache lines in the cache data 320. That is, for each Id_MetaData structure 450 there is a corresponding MetaData_Block structure 460. As illustrated in FIG. 4B, the MetaData_Block structure 460 includes a sequence number, Cmd_pending, and Update_pending fields. The sequence number field includes information that identifies the last sequence number which was used for this metadata block. The Update_pending field includes information that allows the storage controller 200 to identify if there is an I/O operation waiting for an ongoing metadata block update to finish. The Cmd_pending field includes information that enables the storage controller 200 to identify the number of I/O commands waiting for this meta data block update to finish. One or more additional fields may be incorporated in the MetaData Block structure 460 as may be desired to manipulate data or provide additional metadata management functions or operations.

An MBlock structure 440 includes eight data fields that are populated and manipulated by various logic elements or modules within the storage controller 200. A word, identified in FIG. 4B, as a specialword includes information that directs or instructs the storage controller 200 that the memory 220 is arranged with data structures that include the described novel metadata layout.

In addition to the described data structures, a Globals structure 420 is populated and maintained by various logic elements or modules within the storage controller 200. The Globals structure 420 includes eighteen data fields. In alternative embodiments less data fields, the same total number of data fields including one or more replacements for the listed data fields, or more data fields may be created and maintained. The Globals structure data fields include multiple levels of dirtyCacheLineBitmaps, a freeCacheLineBitmap, multiple levels of recently used or RUBitmaps, as well as, a cacheLineArray, SSDWindowArray, flushVDquotient, flushExtensionArray, FlushExtensionArrayFreeBitmap, metBlockArray and a metaUpdatePendingCmd fields.

The dirtyCachelineBitmap fields each include one bit per cache line in the cache data 320. The storage controller 200 uses the corresponding bit as an indication that the corresponding cache line is dirty. The various levels of dirtyCacheLineBitmaps labeled as Level 1, Level 2 and Level 3 provide a mechanism for efficiently searching and identifying which cache lines in the cache data 320 include information that has been modified in the cache such that it no longer matches what is stored in the storage array 250.

The freeCachelineBitmap field includes one bit per cache line in the cache data 320. The storage controller 200 uses the corresponding bit to indicate if the cache line is free or whether the cache line is used. A cache line is used when the cache line includes data.

The data fields RUBitmap1 to RUBitmap5 are bitmaps that each include one bit per cache line in the cache data 320. The corresponding bits are used by the storage controller 200 to indicate if the respective cache line is recently used. When a cache line is accessed the corresponding bit of this cache line in RUBitmap5 is set. A timer is maintained and on each timeout, the values of RUBitmap5 are moved to RUBitmap4, the values in RUBitmap4 are moved to RUBitmap3 and so on. RUBitmap5 is zeroed out. Thus, RUBitmap5 reflects the most-recently used state of the respective cache line. RUBitmp1 reflects the state 5 time-periods earlier.

The metaBlockArray field includes information defining an array with one entry per metadata block structure 460. The cacheLineArray field is another array with one entry per cache line structure 410. The ssdWindowArray field includes information defining an array with one entry per window structure 430. The flushExtensionArray field includes information that defines an array with one entry per dirty cache line in the cache data 320 that is presently getting flushed. The flush ExtensionArrayFreeBitmap field includes one bit for each entry of the flushExtensionArray field, implying if the corresponding flushExtensionArray information is in use or not. The metaUpdatePendingCmd field includes information that defines an array with a list of pending commands which are waiting for the meta data update to complete for a given meta data block. The flushVdQuotient field includes an entry that corresponds to each logical identifier or target identifier used to describe host or source data 310 supported by the storage controller 200. The flushVDQuotient field is used by the storage controller 200 when flushing dirty cache lines.

FIG. 6 illustrates an embodiment of a state diagram implemented by the state-machine logic 226 and processor 210 of FIG. 2. A respective cache line in the cache data 320 can be in one of five states, designated Free 610, Dirty Recently Used (DRU) 630, Dirty-Not Recently Used (DNRU) 650, Recently Used (RU) 620, and Not Recently Used (NRU) 640. The current state of the respective cache line is indicated by the logical values stored in the corresponding bits of the dirtyCachelineBitmap, freeCachelineBitmap, MRUBitmap and RU Bitmaps. A cache line ‘n’ is in, the Free state, if the ‘n’-th bit in the usedCachelineBitmap is set to a logical 0. A cache line ‘n’ is in the RU state, if the ‘n’-th bit in RUBitmap5 or RUBitmap4 is set to a logical 1. A cache line ‘n’ is in the NRU state, if the corresponding bits in both RUBitmap5 and RUBitmap4 are logical 0. A cache line ‘n’ is in the DRU state, when the condition of the RU state is satisfied and the ‘n’-th bit in the dirtyCachelineBitmap is set to a logical 1. A cache line is in the DNRU state, when the condition of the NRU state is satisfied and the ‘n’-th bit in the dirtyCachelineBitmap is set to a logical 1.

Upon initialization of the storage controller 200 the state machine logic 226 considers all available cache lines are in the Free state, as indicated by reference bubble 610. When cache lines get allocated from the Free state, the cache line transitions to one of either the DRU state, as indicated by transition arrow 614 and reference bubble 630, or the RU state, as indicated by transition arrow 612 and reference bubble 620, depending on if the operation was a write operation or a read operation, respectively.

Periodically, as indicated by transition arrow 632 and transition arrow 626, the unused cache lines for a desired number of periods are moved from the RU and DRU states to the NRU and DNRU states, respectively. That is, when a timeout condition exists as identified by the passing of the desired number of periods of time, a cache line in the DRU state transitions to the DNRU state. Similarly, when a timeout condition exists for a cache line in the RU state, the cache line transitions to the NRU state.

When a cache line in the RU state gets accessed within the desired time by a read operation, as indicated by transition arrow 622, the cache line continues in the RU state represented by reference bubble 620. When a cache line in the RU state gets accessed within the desired time by a write operation, the cache line transitions to the DRU state, as indicated by transition arrow 624. When a cache line in the DRU state is accessed within the desired time by either a read or a write operation, as indicated by transition arrow 632, the cache line remains in the DRU state.

As indicated by flow control arrow 644, a cache line transitions from the NRU state, represented by reference bubble 640, to the DRU state represented by reference bubble 630 when a write I/O operation identified a logical block address associated with already cached data. As indicated by flow control arrow 646, a cache line transitions from the NRU state, represented by reference bubble 640, to the RU state, represented by reference bubble 620 when a read hit is identified. Since each cache line maps to a logical block address range, when a read I/O operation identifies the same logical block address that is cached, there is a cache hit and the cache line is considered recently used. Conversely, as indicated by the flow control arrow 648, a cache line transitions from the NRU state, represented by reference bubble 640 to the RU state, represented by reference bubble 620, when the I/O operation identifies a cache line that does not contain matching cached data. When this is the case new data became “hot” and when necessary a cache line is reused by evicting old data. As indicated by the flow control arrow 642, a cache line transitions from the NRU state, represented by reference bubble 640 to the DRU state, represented by reference bubble 630, when the I/O operation identifies a cache line that does not contain matching cached data. When this is the case new data became “hot” and is written to a cache line.

As indicated by transition arrow 652, a cache line in the DNRU state illustrated by reference bubble 650 transitions to the DRU state if the cache line receives a read or write hit within a desired time period. Otherwise, as indicated by transition arrow 654, a cache line in the DNRU state gets flushed and moves to NRU state. Note that cache line allocation to I/O happens only from the Free state 610 and the NRU state 640.

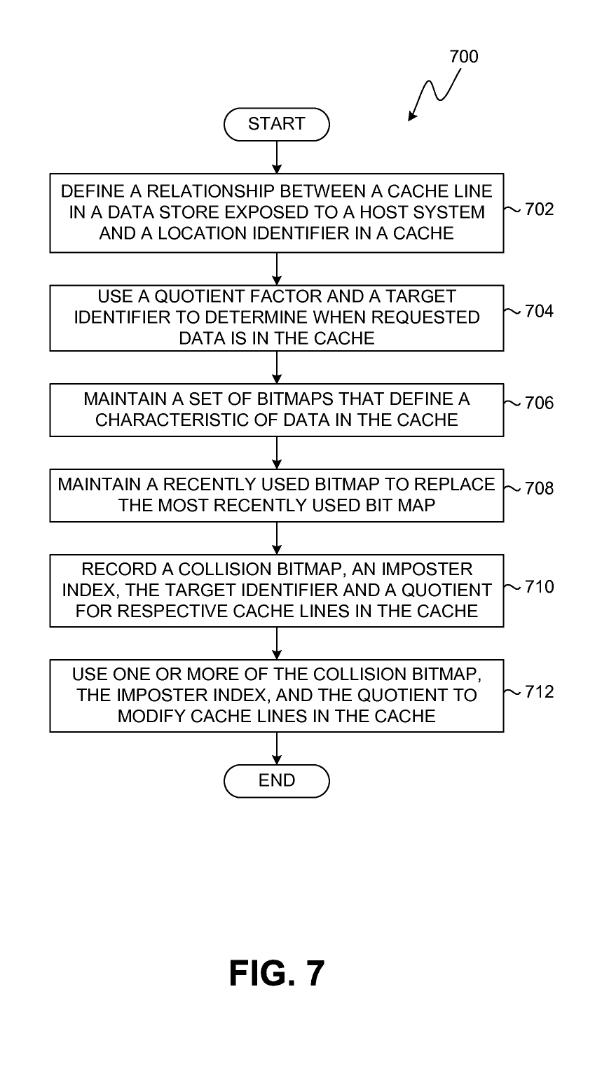

FIG. 7 is a flow diagram illustrating a method 700 for managing metadata operations in a cache supported by a solid-state memory element. The method 700 begins with block 702 where a relationship is defined between a cache line in a data store or logical volume exposed to a host system and a corresponding location identifier in a cache store. As described, the relationship may include a base or direct relationship or mapping as well as one or more offsets or jump locations within the cache store. In block 704, a storage controller 200 and more specifically map management logic 224 uses a quotient factor and a target identifier to identify when requested data is in the cache store. In block 706, storage controller 200 maintains a set of bitmaps that define a characteristic of data in the cache. The characteristic may include whether the data in the cache is dirty or valid. In block 708, the storage controller 200 and more specifically map management logic 224, maintains a recently used bitmap to replace the most recently used bitmap. In block 710, the storage controller 200 records a collision bitmap, an imposter index, the target identifier and a quotient for respective cache lines in the cache store. Thereafter, as indicated in block 712, the storage controller 200 uses one or more of the collision bitmap, the imposter index and the quotient to modify cache lines in the cache store.

It should be understood that method 700 includes steps that include preliminary steps for establishing a metadata structure and bitmaps that are used by the storage controller to maintain and manage metadata stored in a solid-state memory element. The preliminary steps are performed upon power up or reset of a storage controller 200. Once initialized the state machine logic 226 implements the state transitions illustrated and described in association with the state diagram in FIG. 6.

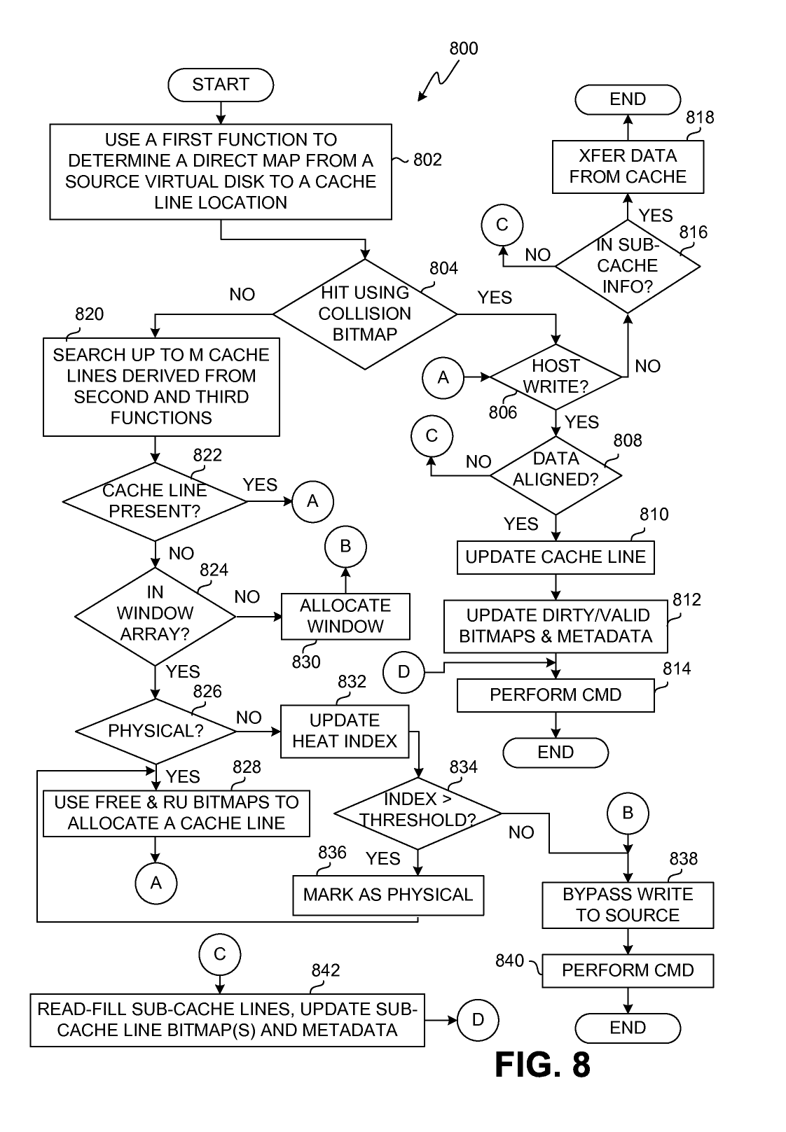

FIG. 8 is a flow diagram illustrating a method 800 for processing a host system directed input/output operation. Method 800 begins with block 802 where a first or base equation is used to determine a direct map or relationship from a location in a source virtual disk to a location in a cache store. In decision block 804, a storage controller 200 uses a collision map to determine if data is present in the cache store at the location identified in block 802. When the response to the query in block 804 is affirmative and as shown in decision block 806 the storage controller 200 determines if the present I/O operation is a write request. Otherwise, when the response to the query in block 804 is negative, the storage controller 200 continues with the search function illustrated in block 820.

When the response to the query in decision block 806 is affirmative, the storage controller 200 proceeds by making a determination as to the alignment of the data to be written with the storage locations in the cache data 310. When the data to be written is in alignment, the storage controller 200 continues by updating the designated cache line as indicated in block 810. Thereafter or in conjunction with updating the cache line, the storage controller 200 updates the dirty bitmap the valid bitmap and metadata, as indicated in block 812, before completing the command as indicated in block 814. Otherwise, when the data to be written is not aligned, in accordance with on-page reference C, the storage controller 200 continues with the functions illustrated in block 842. These functions include performing a read-fill over the sub-cache lines of interest, updating the corresponding sub-cache line dirty bitmap and the sub-cache line valid bitmap and modifying the metadata to reflect the changes. Once the functions in block 842 are completed and as shown by on-page reference D the I/O command is completed as indicated in block 814.

When the response to the query in decision block 806 is negative, that is the host I/O is a read request, the storage controller 200 proceeds by making a determination as to the requested information is available in a sub-cache portion, as indicated in decision block 816. When the data is in the sub-cache portion, as indicated in block 818, the storage controller 200 continues by transferring the data from the cache. Otherwise, when the requested data is not present in the sub-cache portion, in accordance with on-page reference C, the storage controller 200 continues with the functions illustrated in block 842. These functions include performing a read-fill over the sub-cache lines of interest, updating the corresponding sub-cache line valid bitmap and modifying the metadata to reflect the changes. Once the functions in block 842 are completed, as shown by on-page reference D, the I/O command is completed, as shown in block 814.

When the response to the query in block 804 is negative, the storage controller 200 searches a desired number of cache line storage locations derived from the described first jump equation (e.g., Eq. 2) and the described second jump equation (e.g., Eq. 3). When a cache line is present at one of the jump locations or in the desired number of contiguous cache line storage locations thereafter the respective jump location, in accordance with on-page reference A, the storage controller 200 continues with the query in decision block 806 as previously described. Otherwise, when the cache line is not present at the locations defined by the first and second jump locations the storage controller 200 performs the query in decision block 824 to determine if the data is present in a storage window. When the data is present in a storage window the storage controller 200 performs the query in decision block 826 to determine when the storage window is physical. When the storage window is physical the storage controller 200 uses the free bitmap and the recently used bitmaps to allocate a cache line. Thereafter, in accordance with on-page reference A, the storage controller 200 continues with the query in decision block 806 as previously described.

Otherwise, when the response to the query in decision block 826 is negative, the storage controller 200 updates a heat index as indicated in block 832 and performs the query in decision block 834 to determine when the heat index exceeds a threshold. When the heat index exceeds the threshold, the storage controller 200 marks the storage window “physical” and uses the free bitmap and the recently used bitmaps to allocate a cache line to the I/O operation before continuing with the query in decision block 806 as previously described.

Upon completion of the allocation of the storage window in block 830 or when it is determined that the heat index does not exceed a threshold as indicated by a negative response to the query in decision block 834 (and in accordance with on-page reference B) the storage controller 200 continues with block 838 where the write to cache operation is bypassed and the source VD is used. Thereafter, as shown in block 840, the storage controller 200 completes the I/O command.

It should be understood that the flow diagrams of FIGS. 7 and 8 are intended only to be exemplary or illustrative of the logic underlying the described methods. Persons skilled in the art will understand that in various embodiments, data processing systems including cache processing systems or cache controllers can be programmed or configured in any of various ways to effect the described methods. The steps or acts described above can occur in any suitable order or sequence, including in parallel or asynchronously with each other. Steps or acts described above with regard to FIGS. 7 and 8 can be combined with others or omitted in some embodiments. Although depicted for purposes of clarity in the form of a flow diagram in FIGS. 7 and 8, the underlying logic can be modularized or otherwise arranged in any suitable manner. Persons skilled in the art will readily be capable of programming or configuring suitable software or suitable logic, such as in the form of an application-specific integrated circuit (ASIC) or similar device or a combination of devices, to effect the above-described methods. Also, it should be understood that the combination of software instructions or similar logic and the local memory 220 or other memory in which such software instructions or similar logic is stored or embodied for execution by processor 210, comprises a “computer-readable medium” or “computer program product” as that term is used in the patent lexicon.

The claimed storage controller and methods have been illustrated and described with reference to one or more exemplary embodiments for the purpose of demonstrating principles and concepts. The claimed storage controller and methods are not limited to these embodiments. As will be understood by persons skilled in the art, in view of the description provided herein, many variations may be made to the embodiments described herein and all such variations are within the scope of the claimed storage controller and methods.

What is claimed is:

1. A method for managing metadata operations in a cache supported by a solid-state memory element, the method comprising:
defining a mathematical relationship between a segment in a data store exposed to a host system by a target identifier and a location identifier associated with a cache line in the solid state-memory element;
using a quotient factor and the target identifier to determine when requested data is present in the cache;
maintaining a set of bitmaps that define at least one characteristic of data present in a cache line in the solid-state memory element;
maintaining a recently used bitmap that is available to replace the most recently used bitmap;
recording a collision bitmap, an imposter index, the target identifier and a quotient for respective cache lines in the cache; and
using one or more of the collision bitmap, the imposter index and the quotient to modify cache lines stored in the solid-state memory element.

2. The method of claim 1, wherein defining a relationship between the segment and a location identifier is responsive to a set of functions that define an M-set associative cache.

3. The method of claim 2, further comprising:
receiving, with a storage controller, an input/output operation request from a host, the input/output operation request defining a segment of interest;
checking if the cache line corresponding to the segment of interest is in the cache store;
when the cache line corresponding to the segment of interest is not stored in the cache, identifying a cache miss, and bypassing the cache.

4. The method of claim 2, wherein the set of functions include a first function that defines a direct relationship between a segment in the data store and a corresponding location in the cache store.

5. The method of claim 4, wherein the set of functions include a second function that defines a first alternative location in the cache store and a third function that defines a second alternative location in the cache store.

6. The method of claim 4, further comprising alternative locations that sequentially follow an offset location removed from the corresponding location.

7. The method of claim 2, further comprising:
receiving, with a storage controller, an input/output operation request from a host, the input/output operation request defining a segment of interest;
checking if the cache line corresponding to the segment of interest is in the cache store, wherein checking includes, selecting a first function from the set of functions to determine a base location;
checking the base location for a base cache hit;
when a base cache miss is identified, using the collision bitmap to identify at least one alternate location, when a bit is set to identify the at least one alternate location, checking the alternate location for an alternate cache hit; and
when an alternate cache miss is identified, storing data in a virtual window and bypassing the cache.

8. The method of claim 7, further comprising:
determining when the virtual window is hot;
identifying a base location, when the base location is unused, storing the data from the virtual window in the base location;
otherwise, when the base location is occupied,
checking a member of the set of bitmaps that define at least one characteristic of data present in the cache line for an unused alternate location;
when unused,
updating the collision map; and
storing the data from the virtual window;
when all alternatives are occupied,
consulting the most recently used bitmap and the recently used bitmap to identify an eviction candidate.

9. The method of claim 1, further comprising:
using corresponding bits in the recently used bit map, the most recently used bitmap, and the set of bitmaps that define at least one characteristic of data present in a cache line in the solid-state memory element to identify a present state of a cache line in the cache store.

10. The method of claim 9, wherein a cache line “n” is in a free state when an “n”-th bit in a used bitmap in the set of bitmaps that define at least one characteristic of data present in the cache is set to a predetermined logical value.

11. The method of claim 9, wherein a cache line “n” is in a recently used state when an “n”-th bit in an “m”-th recently used bit map is set to a predetermined logical value or when an “n”-th bit in an “m”-th−1 recently used bit map is set to a predetermined logical value.

12. The method of claim 11, wherein a cache line “n” is in a not recently used state when an “n”-th bit in an “m”-th recently used bit map is set to an opposed logical value and when an “n”-th bit in an “m”-th−1 recently used bit map is set to the opposed logical value.

13. The method of claim 11, wherein a cache line “n” is in a dirty and recently used state when it is recently used and an “n”-th bit in a dirty bitmap in the set of bitmaps that define at least one characteristic of data present in the cache is set to a predetermined logical value.

14. The method of claim 13, wherein a cache line “n” is in a dirty and not recently used state when it is not recently used and an “n”-th bit in a dirty bitmap in the set of bitmaps that define at least one characteristic of data present in the cache is set to a predetermined logical value.

15. A storage controller, comprising:
a first interface for communicating with a host system, the first interface communicating data and command signals with the host system;
a processor coupled to the interface by a bus;
a solid-state memory element coupled to the processor by the bus having stored therein state machine logic responsive to a quotient and a set of functions that define a set-associative cache, a first subset of functions that define a cache address from a host managed address, a second subset of functions that define a host managed address from a cache address, the state machine logic configured to manage the reuse of cache line addresses responsive to recently used bit maps;
a global bitmap module, responsive to a global bitmap,
a collision detection module, responsive to a collision bitmap,
an imposter detection module, responsive to an imposter index; and
a second interface coupled to the processor by the bus, the second interface communicating data with a set of data storage elements supporting a logical volume.

16. The storage controller of claim 15, wherein the global bitmap module sets a bit associated with a respective cache line address.

17. The storage controller of claim 15, wherein the collision detection module uses “n” bits of a cache line to identify that a base location in the cache is in use.

18. The storage controller of claim 15, wherein the imposter detection module identifies when data stored at the present location arrived from an invalid base location.

19. The storage controller of claim 15, wherein the imposter detection module determines a valid base location.

20. The storage controller of claim 15, wherein the quotient store includes a value that is used to determine a logical block address.
